(19) United States
(12) Patent Application Publication
(10) Pub. No.: US 2009/0242492 A1
(43) Pub. Date: Oct. 1, 2009

(54) SUBSURFACE WASTEWATER DISPOSAL SYSTEM

(76) Inventor: Rodney Ruskin, San Rafael, CA (US)

Correspondence Address: CHRISTIE, PARKER & HALE, LLP, PO BOX 7068, PASADENA, CA, 91109-7068, US

(21) Appl. No.: 12/413,375

(22) Filed: Mar. 27, 2009

Related U.S. Application Data
(60) Provisional application No. 61/072,761, filed on Apr. 1, 2008.

(51) Int. Cl. C02F 3/30; C02F 103/00

(52) U.S. Cl. 210/747; 210/605

(57) ABSTRACT

A wastewater treatment and disposal system includes a pressure system for forcing wastewater effluent from a treatment tank to a subsurface dispersal/reuse area. Filtered effluent is discharged into the dispersal area through a system of drip irrigation-type driplines contained inside separate elongated, generally tubular sleeve-like enclosures running along the length of each dripline. The sleeve-like enclosures are made of flexible geotextile subsurface drainage fabric for spreading out the effluent discharged to the dispersal area from the driplines. At least a portion of the drainage fabric may contain an herbicide for forming a “biobarrier” that inhibits undesired root growth into the fabric. The sleeved geotextile fabric can set up a biologically active zone in the ground around the dripline. Air can be injected into the biologically active zone through the dripline emitters for dewatering and/or for treating an anaerobic condition in the zone, for changing the zone to a more aerobic condition.

### CROSS-REFERENCE

This application is based upon and claims priority on U.S. Provisional Application No. 61/072,761, filed on Apr. 1, 2008, the contents of which are fully incorporated herein by reference.

### FIELD OF THE INVENTION

This invention relates to wastewater disposal systems generally, and more particularly, to an improved onsite subsurface wastewater disposal system.

### BACKGROUND

Use of subsurface drip irrigation is an efficient method to dispose of effluents. Small, precise amounts of water are uniformly applied under the soil surface from multiple points. Wastewater disposal using such drip irrigation systems is commonly used for domestic dwellings or other limited-volume wastewater sources. Wastewater is first treated in an anaerobic environment. The primary-treated wastewater is then sent for secondary treatment in an aerobic system. The wastewater effluent from the secondary treatment system is relatively environmentally benign, so it can be disposed of in a buried wastewater disposal system. Such a wastewater disposal system is available form Geoflow, Inc., Corte Madera, Calif., under the designation WASTEFLOW and is described online via its “Subsurface Drip for Onsite Wastewater Reuse and Dispersal” guidelines at Geoflow.com.

Such wastewater disposal systems carry the wastewater into the disposal/reuse area via drip irrigation lines with spaced apart drip emitters (referred to as driplines) which are well known in the art. The dripline products available from Geoflow can include use of drip emitters protected against the hazards of root growth intrusion by the root growth inhibitor trifluralin (also known as Treflan), which is fused into the drip emitter during the manufacturing process. Dripline using such root growth inhibiting emitters is described in U.S. Pat. No. 6,821,928 to Ruskin and available from Geoflow under the marks ROOTGUARD and nano-ROOTGUARD.

Dripline used for the subsurface disposal of wastewater also can be subject to bacterial growth on the inside of the tubing. Geoflow's WASTEFLOW dripline tubing contains an anti-bacterial lining that prevents undesired build up of bacterial growth on the insides of the tubing and the emitters.

Applying wastewater to the soil from buried spaced apart drippers has a limited volume of soil into which the wastewater emerges. The efficient dispersal of wastewater in very heavy soils also can produce an undesired anaerobic biomat forming around the tube. The present invention provides an improved method for disposing of wastewater through buried driplines.

Wastewater usually contains nitrogen in several forms. Nitrification and denitrification under alternating anaerobic and aerobic conditions can reduce the amount of nitrogen that passes down into the groundwater.

### SUMMARY OF THE INVENTION

The present invention addresses these problems by providing a subsurface geotextile fabric layer adjacent the dripline for use in spreading out the wastewater emerging from the dripline into the surrounding soil. In one embodiment, the geotextile fabric layer comprises a “biobarrier” containing a root growth inhibiting material that prevents root growth from plugging the biobarrier during use.

Use of the wastewater disposal system is further improved upon for very heavy soils by use of a dewatering system that prevents formation of an undesired anaerobic biomat around the tube.

In one embodiment, the invention comprises a wastewater treatment and disposal system which includes a pressure system for forcing wastewater effluent from a treatment tank to a subsurface dispersal/reuse area. Filtered effluent is discharged into the dispersal area through a system of drip irrigation-type driplines containing regularly spaced drip emitters laid underground between supply and return manifolds. The dripline conduits are contained inside separate elongated, generally tubular sleeve-like enclosures running continuously along the length of each dripline. The sleeve-like enclosures are made of flexible, preferably non-woven geotextile to provide a subsurface drainage fabric for spreading out the effluent discharged to the dispersal field from the driplines. At least a portion of the sleeve-like drainage fabric can be studded with an array of pellets containing an herbicide, such as trifluralin, for forming a “biobarrier” that inhibits undesired root growth into the geotextile fabric. The dripline tubing contained inside the tubular drainage fabric can comprise standard dripline, dripline having the drip emitters protected against root intrusion by a similar herbicide, dripline having an antibacterial inner lining, or dripline containing the antibacterial lining along with the root-growth protected emitters. The drainage fabric may contain the herbicide pellets on an upper portion of the tubular fabric or spread out essentially around its entire periphery. The drainage fabric may encompass the dripline as a single layer or as a dual layer. The sleeved geotextile fabric can set up a biologically active zone in the ground around the dripline. Air can be injected into the biologically active zone for dewatering and/or treating an anaerobic condition in the zone and for changing the zone to a more aerobic condition.

These and other aspects of the invention will be more fully understood by referring to the following detailed description and the accompanying drawings.

### BRIEF DESCRIPTION OF THE DRAWINGS

FIG. 1 is a schematic view illustrating a wastewater disposal system for supplying wastewater to a dispersal/reuse area via a system of drip emitters.

FIG. 2 is a fragmentary perspective view showing a dripline containing spaced apart emitters representing a type of dripline that can be used with the invention.

FIG. 3 is a schematic view of a piece of drainage fabric made of a geotextile and containing pellets of an herbicide.

FIG. 4 is a fragmentary perspective view showing a dripline inside with a tubular drainage fabric and biobarrier according to principles of this invention.

FIG. 5 is a schematic view illustrating a dripline encompassed by two layers of drainage fabric with the outer layer portion studded with herbicide pellets.

FIG. 6 is a schematic view, similar to FIG. 5, but showing a single layer of drainage is fabric studded with the herbicide pellets.

FIG. 7 is a schematic view showing an embodiment similar to FIG. 5, but without the herbicide-containing pellets.

FIG. 8 is a schematic view showing an embodiment similar to FIG. 6, but without the herbicide-containing pellets.

FIG. 9 is an embodiment in which the dripline is contained within two layers of drainage fabric, in which the outer layer is studded essentially continuously around its periphery with an array of herbicide-containing pellets.

FIG. 10 is an embodiment similar to FIG. 9, but having a single layer of drainage fabric studded with herbicide-containing pellets above and below the dripline.

FIG. 11 is a schematic illustration of a biologically active zone surrounding a conventional buried dripline.

FIG. 12 is a schematic illustration of a biologically active zone spread out along a buried dripline when using the geotextile fabric type sleeve according to principles of this invention.

FIG. 13 is a schematic illustration of a wastewater disposal system having a geotextile fabric sleeve and buried dripline, with air forced through the dripline into a biologically active zone for treating an anaerobic condition.

FIG. 14 is a schematic illustration of a system for supplying air to the biologically active zone of FIG. 13.

### DETAILED DESCRIPTION

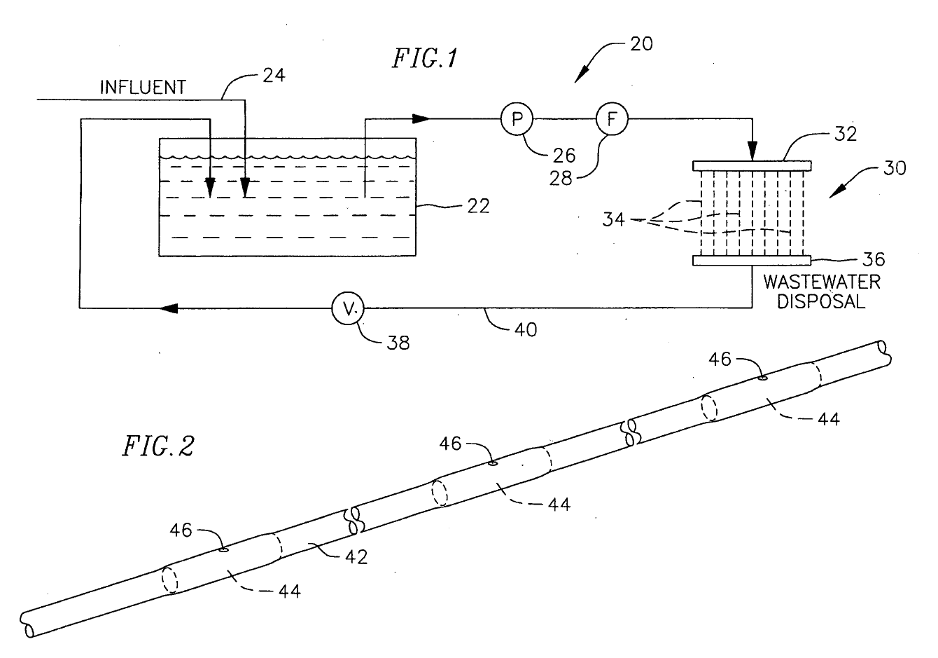

FIG. 1 illustrates one embodiment of a subsurface wastewater disposal system 20 which includes a treatment tank 22 having an inlet line 24 for an influent typically from a primary or secondary treatment source. The wastewater effluent from the treatment tank is sent through a system of pumps, valves and filters, in various forms known in the art. The figure illustrates a simplified system with a pump 26 which forces the wastewater effluent under pressure through a filter 28 and into a subsurface disposal system 30.

The subsurface disposal system includes an inlet manifold 32 and an array of buried driplines 34 leading from the inlet manifold to an outlet manifold 36. The wastewater from time to time requires flushing of the drip emitters. Flushing in the dripper field occurs via a field flush valve 38 in a return line 40. The valve 38 is normally closed but can be opened for returning effluent to the treatment tank 22 during the flushing cycle.

FIG. 2 illustrates an example of the buried dripline 34 which comprises a drip irrigation tubing 42 containing internally spaced apart drip emitters 44. Wastewater emerges at a slow drip rate from the dripline through separate outlet holes 46 in the drippers. The dripline can be the type of irrigation tubing containing the drip emitters available from Geoflow for use with its WASTEFLOW wastewater reuse and dispersal system described previously.

The present invention includes use of a flexible, porous geotextile-type fabric disposed in a position in the ground around at least the portion of the wastewater dispersal dripline. The geotextile fabric is preferably formed as a sleeve, or at least a portion of a sleeve, buried in the ground and disposed adjacent the dripline. The sleeve-like layer of fabric is useful in spreading wastewater effluent into the subsurface drainage field. The fabric layer is referred to herein as sleeve-like in the sense that it encompasses at least a portion of the dripline when viewed in cross-section, i.e., it can partially or essentially completely surround the dripline.

The term “geotextile” is used herein generally to describe various types of fabric materials useful with the present invention. These fabrics are useful because they aid in drainage and are often referred to as “drainage fabrics.” Because of their permeability, they are useful in subsurface drainage applications when buried in the ground. They can absorb wastewater emerging from the dripline and spread it into the soil along the dripline and outwardly above and below the dripline. In one embodiment of the invention, the geotextile layer is used as a buried medium for controlling biological growth. The geotextile fabric is positioned adjacent to or around the buried wastewater dripline and can be used to control dispersion of the wastewater effluent passing from the drippers into the surrounding soil. The geotextile fabric also can be useful in certain instances because it is able to provide erosion control.

The geotextile fabric materials can be made from various synthetic polymers including polyester, polyethylene, polypropylene and polyamide. And the fabric can be in various forms including nonwoven, knitted, woven, and also in some instances can be made from geosynthetics or used in geogrid or mesh form. The geotextile material is characterized by the synthetic resin fibers having sufficient tensile strength and resistance to long term deterioration when buried underground to resist decomposition in the soil, at least more than one year. In addition to being used in subsurface drainage, the material also can be used as a weed or root barrier.

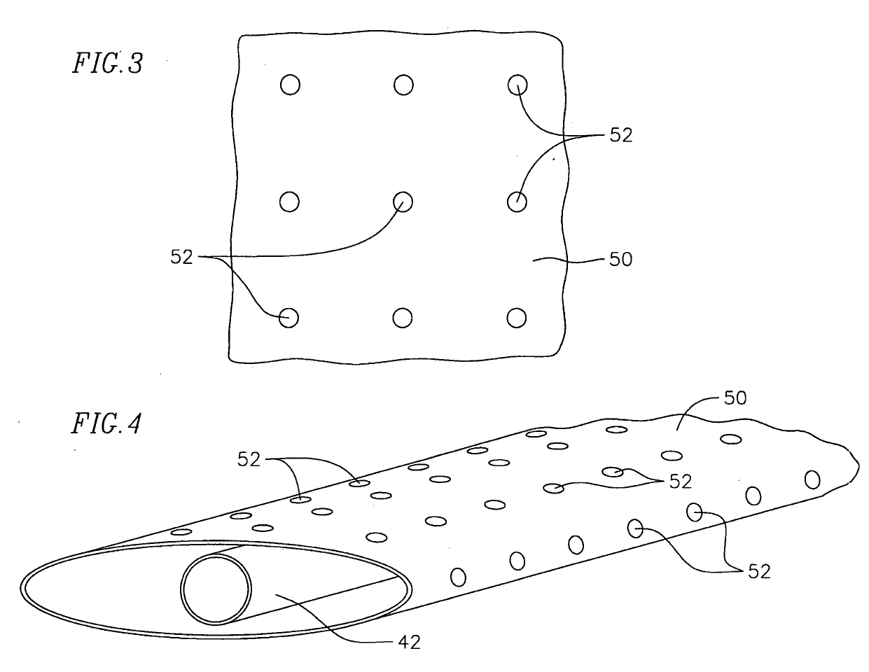

FIG. 3 shows a form of the invention in which the geotextile fabric layer can be used as a “biobarrier.” In this instance the geotextile comprises a drainage fabric 50 containing embedded segments or pellets 52 of an herbicide. In the illustrated embodiment, the pellets of herbicide are spaced apart on a grid pattern, although other spacing patterns can be used. The herbicide, in one embodiment, can comprise trifluralin, and use of the geotextile is for protection against root growth intrusion in buried applications. In one embodiment, the geotextile fabric 50 when used as a “biobarrier” can be a nonwoven form of the drainage fabric material. The material shown in FIG. 3 can be supplied by Fiberweb, Inc. and is sold under the trademark BioBarrier.

FIG. 4 illustrates one embodiment of the invention in which a sleeve-like form of the geotextile, such as the layer of material shown in FIG. 3, is disposed around a dripline 42 for use in buried applications. In this embodiment, the dripline can be one of an array of driplines used in a subsurface disposal area. The dripline is positioned with the geotextile material surrounding the dripline, spaced radially outwardly from the dripline, and running the length of the dripline. In the embodiment shown in FIG. 4, the sleeve-like geotextile material is essentially completely surrounding the dripline, preferably located at least above the dripline, although as mentioned, in other embodiments only a portion of the dripline may be encompassed by the adjacent geotextile. The geotextile fabric is positioned “adjacent” to the dripline in the sense that the spacing is effective in causing the water emerging from the dripline to pass through the soil and be spread out in the soil in an active zone adjacent the dripline. The geotextile fabric is characterized as “sleeve-like” in the sense that it has a configuration that encompasses at least a portion of the adjacent dripline. Preferably, the sleeve-like configuration is generally elliptical in cross-section, in which the geotextile extends farther in a lateral direction from both sides of the dripline, and for a shorter dimension both upwardly and downwardly away from the dripline, although other arrangements are possible.

In use, the geotextile material can keep roots away from the fabric and prevent the fabric from being plugged by root growth. The effluent is dispersed generally uniformly along the length of the dripline tube by means of the drippers generally positioned along the center of the sleeve-like geotextile. By dispersing the wastewater effluent to the ground via the surrounding geotextile, as opposed to dispersing effluent directly to the soil from the drippers, dispersion is improved because the volume of soil an direct contact with the effluent, as it emerges from the geotextile, is many times the volume of soil otherwise close to the drippers.

The positioning of the driplines in the drainage field can vary, depending on the effluent and soil conditions. In one embodiment, the drippers are spaced between 2 and 3 feet apart. The usual separation for drippers down the line for sewage disposal is between about 1 and 2 feet. The driplines can be as wide as 5 feet apart, compared to the usual width for sewage disposal of 2 feet apart.

FIGS. 5 to 10 schematically illustrate various embodiments in which a geotextile drainage fabric can be used in combination with the dripline for dispersing wastewater effluent into the ground.

FIG. 5 illustrates the dripline 42 disposed within two layers of the drainage fabric. The outer layer 50 is studded with the herbicide pellets 52, and an inner layer 54 of geotextile fabric is disposed in the space between the outer layer 50 and the dripline 42. The inner layer 54 omits the pellets. In this embodiment, the herbicide pellets 52 are located only on an upper portion of the outer layer 50 to inhibit root growth from above.

FIG. 6 schematically illustrates an embodiment similar to FIG. 5, but in this instance the single layer 50 of geotextile with the herbicide pellets 52 is used.

FIG. 7 schematically illustrates a two-layer embodiment similar to FIG. 5, except that the herbicide pellets are omitted from both layers 50′ and 50″.

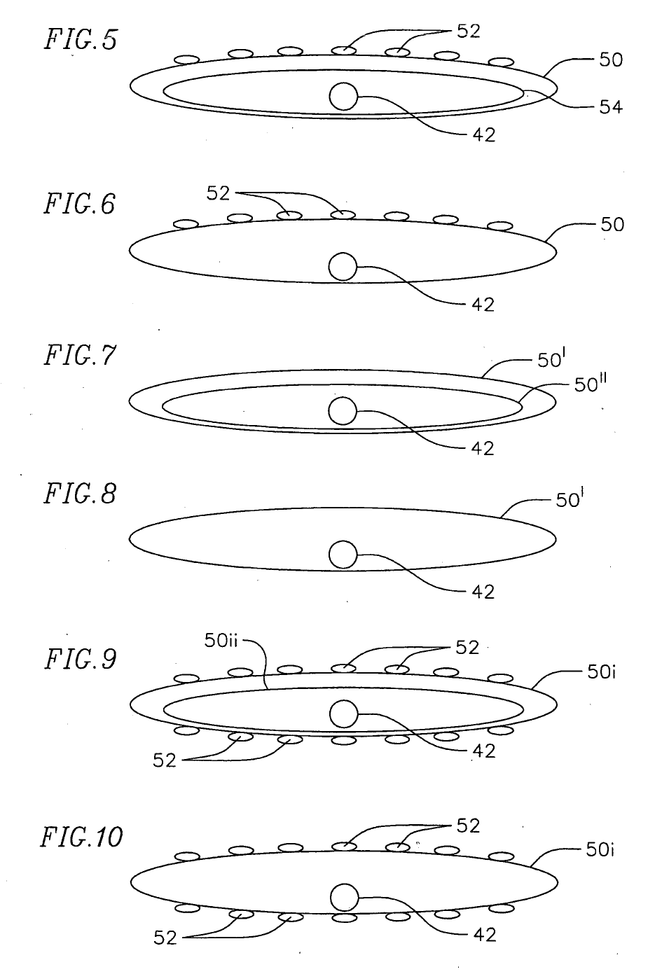

FIG. 8 schematically illustrates an alternative to FIG. 7 in which a single layer 50′ is disposed around the dripline 42.

FIG. 9 schematically illustrates a further embodiment in which two layers of geotextile 50i and 50ii surround the dripline 42. In this instance, the outer layers along both the upper level and lower level contain the pattern of herbicide pellets 52. The inner layer 50ii omits the pellets 52.

FIG. 10 schematically illustrates an embodiment similar to FIG. 9 in which a single layer 50i of geotextile, with the pellets of herbicide at both upper and lower levels, surrounds the dripline 42, omitting the inner layer 50ii shown in FIG. 9.

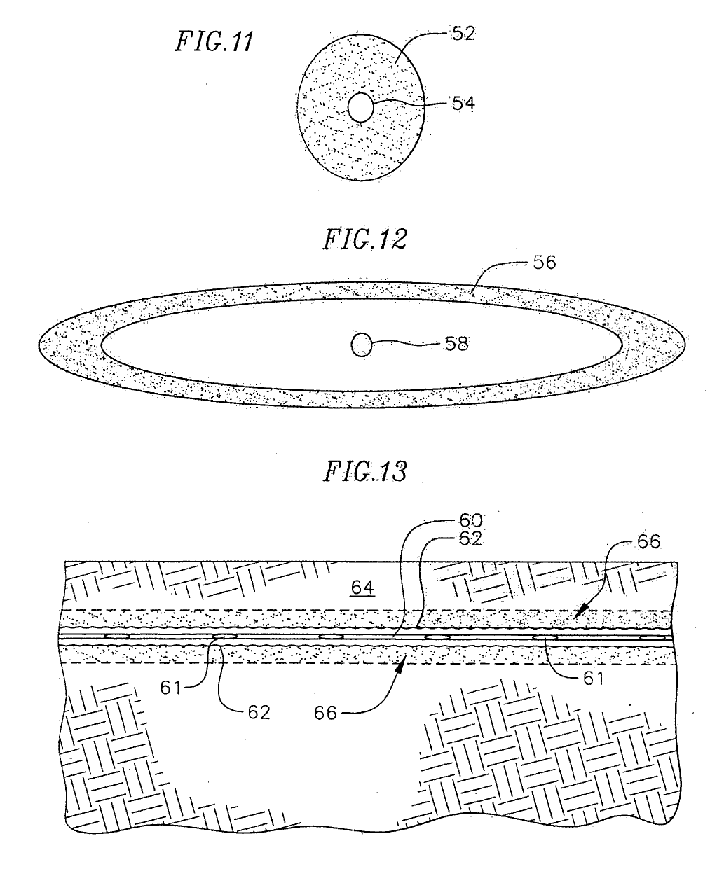

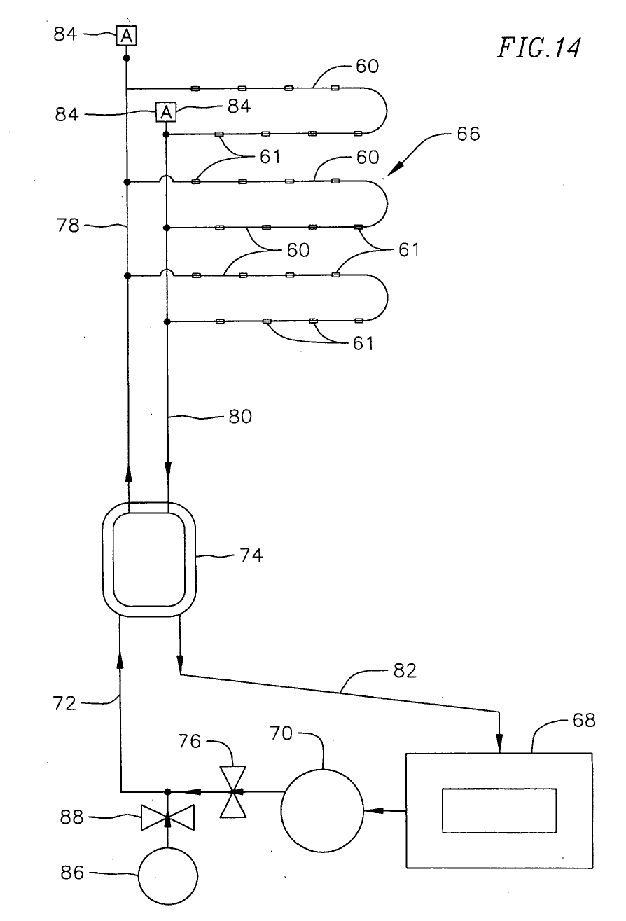

FIGS. 11 and 12 illustrate a comparison between the size of a biologically active zone 52 around a dripline 54, as shown in FIG. 11, and a much larger biologically active zone 56 around a dripline 58 similar to the dripline 54, shown in FIG. 12, but surrounded by the sleeve-like drainage fabric.

It is known from several studies in the past that the biologically active zone around a conventional emitter, where the anaerobic/aerobic cycle takes place, is very small. The size of this zone is soil-dependent, and the radius is as small as 2 to 3 inches. For many years, those in the art have recommended packing extra emitters into the disposal field, when using septic tank effluent, in order to increase the biologically active volume.

For instance,

### Zone Volume:

Conventional drip: 4/3 π r³
With a sleeve of width L and D inches between emitters: 2 LDr.
Example: r=2, D=24 and L=6
Conventional drip biologically active volume=33.5 cubic inches
With sleeve biologically active volume=576 cubic inches
The sleeve method provides about 17 times the volume of soil in which to manage the biological and nitrogen processes described as follows:

FIG. 13 illustrates one embodiment of a dewatering or denitrification technique for managing the nitrogen process in a buried wastewater disposal system. The disposal system includes a dripline 60 (with drippers 61) and a sleeve-like geotextile drainage fabric 62 extending lengthwise below the surface of the ground 64. The geotextile fabric surrounds the dripline, in this embodiment. The figure illustrates a biologically active zone 66 surrounding the emitter and the geotextile drainage fabric. In this embodiment, the sleeve is first dosed with anaerobic tank effluent, for say 24 hours, and thereby sets up an anaerobic zone (the biologically active zone 66) around the emitters of the dripline. Air is forced through the dripline which distributes the air throughout the anaerobic zone to switch the zone to an aerobic condition. It is estimated that an optimum configuration of this technique would be dependent upon the size and spacing and distances apart of the emitters and different types of soils. It is reasonable to expect that due to the substantial increase of active volume, i.e., comparing the conventional system of FIG. 11 with the sleeved dripper arrangement of FIG. 12, will result in a process which is less soil-dependent than disposal by drip irrigation conventionally.

The drainage fabric 62 may be present in any of the configurations shown in FIGS. 5 to 10. The double sleeve concepts shown previously provide even more control of the anaerobic/aerobic cycle and are estimated to be useful in heavy clay soils with very slow water movement through the pores.

FIG. 14 illustrates one embodiment of a system for supplying air to the biologically active zone 66 of FIG. 13. The system includes a septic tank 68 with an effluent pump tank 70 for forcing effluent through a supply line 72 to a headworks 74 through a first check valve 76. The headworks can include a vortex filter and related flush valves similar to those supplied by Geoflow, Inc. under the WASTEFLOW mark. The effluent is delivered to an array of buried driplines 60 via a supply manifold 78. The driplines connect to a return manifold 80 leading back to the return line 82 through the headworks 74. Air/vacuum breakers are shown at 84 at the ends of the manifolds. For delivering air to the biologically active zone during the aeration cycle, an air pump 86 forces air into the supply line 72 through a second check valve 88. The air is distributed to the dripline field through the dripline emitters 61.

The septic tank effluent, such as wastewater, can contain substantial concentrations of ammonium and organic nitrogen compounds which readily mineralize to ammonium. Aerobic treatment (in the present invention, the injection of air) can convert almost all of the ammonium to nitrate. In the soil, nitrate is either denitrified by facultative anaerobic bacteria, taken up by plants, or leached to groundwater. To ensure that the denitrification by the bacteria dominates the process, and that there is little or no nitrogen leached to the groundwater, the anaerobic condition (previously described) is set up in the soil around the dripline. The conversion to the more aerobic condition, from the injection of air, causes desired denitrification (conversion to nitrogen gas).

In order to enhance the denitrification process, it is recognized that a substantial amount of carbon is required to denitrify wastewater effluent. For example, the urine content in wastewater can not be in the neighborhood of 70% or more. In one embodiment of the invention, a substantial proportion, i.e., at least about 50%, of the urine content in the wastewater is separated initially or otherwise removed from the wastewater prior to processing, so that the anaerobic condition (described previously) contains mostly solid waste, with excess nitrogen having been removed. This resulting solid waste is then denitrified, as described previously, with the separated urine or urea content treated independently to remove nitrogen without having caused undesired leaching into the groundwater. The resulting solid waste in its anaerobic condition is then treated with the air injection, as described previously, to convert it to the more desirable aerobic condition.

What is claimed is:

1. A method of delivering wastewater to a subsurface disposal area comprising:
providing a wastewater dispersal line comprising a dripline containing spaced apart drip emitters and a sleeve-like layer of a flexible, porous geotextile fabric,
placing the dripline and the sleeve-like geotextile fabric in a subsurface location within a drainage field, the geotextile fabric positioned adjacent to the dripline and extending lengthwise along the dripline, and
connecting the dripline to a source of wastewater to force the wastewater outwardly from the dripline emitters and through the adjacent geotextile fabric to spread the wastewater into the subsurface drainage field.

2. The method according to claim 1 in which the geotextile fabric contains a root growth inhibiting material.

3. The method according to claim 2 in which the root growth inhibiting material comprises studded regions of an herbicide embedded in the geotextile fabric.

4. The method according to claim 2 in which a second layer of a geotextile fabric is disposed around the dripline in a space between the dripline and the geotextile containing the root growth inhibiting material.

5. The method according to claim 1 in which the dripline emitters contain a root growth inhibiting material.

6. The method according to claim 1 in which the dripline comprises an interior layer of an antibacterial material.

7. The method according to claim 1 in which the wastewater contact with the geotextile fabric produces a biologically active zone in the ground around the dripline; and forcing air into the biologically active zone for dewatering the zone or for changing the zone from an anaerobic to a more aerobic condition.

8. The method according to claim 1 in which the sleeve-like layer of geotextile fabric produces a biologically active zone in the ground around the dripline; and in which air is forced through the dripline and distributed throughout the biologically active zone for dewatering the zone or for changing it from an anaerobic to a more aerobic condition.

9. A wastewater dispersal system for delivering wastewater to a subsurface disposal area comprising:
a wastewater dispersal line comprising a dripline containing spaced apart drip emitters positioned adjacent to a sleeve-like layer of a flexible, porous geotextile fabric extending lengthwise along the dripline,
the wastewater dispersal line and the geotextile fabric layer disposed in a subsurface location within a drainage field,
the dripline connected to a source of wastewater under pressure to force the wastewater outwardly from the dripline emitters and through the geotextile fabric layer to spread the wastewater into the subsurface drainage field.

10. The system according to claim 9 in which the geotextile contains a root growth inhibiting material.

11. The system according to claim 10 in which a second layer of a geotextile fabric is disposed around the dripline in a space between the dripline and the geotextile containing the root growth inhibiting material.

12. The system according to claim 10 in which the root growth inhibiting material comprises studded regions of an herbicide embedded in the geotextile fabric.

13. The system according to claim 10 in which the dripline emitters contain a root growth inhibiting material.

14. The system according to claim 9 in which the dripline comprises an interior layer of an antibacterial material.

15. The system according to claim 9 in which the wastewater contact with the geotextile fabric produces a biologically active zone in the ground around the dripline; and including means for forcing air into the biologically active zone for dewatering the zone or for changing the zone from an anaerobic to a more aerobic condition.

16. The system according to claim 9 in which the sleeve-like layer of geotextile fabric produces a biologically active zone in the ground around the dripline; and in which air is forced through the dripline and distributed into the biologically active zone for dewatering the zone or for changing the zone from an anaerobic to a more aerobic condition.

17. A method for denitrification of effluent, comprising:
providing a wastewater dispersal line comprising a dripline containing spaced apart drip emitters,
placing the dripline in a subsurface ground location within a drainage field,
connecting the dripline to a source of wastewater to distribute the wastewater into a biologically active zone in the ground, the wastewater setting up an anaerobic condition in the biologically active zone adjacent the dripline, and
injecting air into the dripline to distribute the air into the previously set anaerobic condition to denitrify the wastewater therein to convert the zone to a more aerobic condition.

18. The method according to claim 17 including alternating the biologically active zone between anaerobic and aerobic conditions.

19. The method according to claim. 17 in which the anaerobic condition is set up via a geotextile positioned in the ground adjacent the dripline.

20. The method according to claim 17 including the step of reducing the nitrogen content of the wastewater prior to distributing the wastewater into the ground, so that the wastewater distributed via the dripline optionally contains less than 50% nitrogen content.
